(19) United States
(12) Patent Application Publication
(10) Pub. No.: US 2025/0251620 A1
(43) Pub. Date: Aug. 7, 2025

(54) DELAYED DIMMING DEVICE AND DIMMING EYEGLASSES

(71) Applicant: Wicue USA INC., Santa Clara, CA (US)

(72) Inventors: Fenghua LI, Santa Clara, CA (US); Cai Guo, Santa Clara, CA (US); Jinquan ZHU, Santa Clara, CA (US); Yanbin LI, Santa Clara, CA (US)

(73) Assignee: Wicue USA INC., Santa Clara, CA (US)

(21) Appl. No.: 18/435,732

(22) Filed: Feb. 7, 2024

(51) Int. Cl. G02C 7/10

(52) U.S. Cl. CPC G02C 7/101

(57) ABSTRACT

A delay dimming device includes: a first power supply system, an automatic delay driving circuit, a controller, and a dimming device. The first power supply system is a solar power system equipped with a photoreceptor. The first power supply system is connected to the automatic delay driving circuit. The controller receives electrical signals transmitted by the automatic delay driving circuit and controls the dimming device. The first power supply system powers the dimming device and senses the intensity of the ambient light. It transmits the sensed light intensity signals to the automatic delay driving circuit, which then converts these light intensity signals into electrical signals and transmits them to the controller. The controller determines whether delay dimming is necessary based on the transmitted electrical signals.

### TECHNICAL FIELD

The present disclosure relates to a field of liquid crystal film dimming technology, and in particular, to a delayed dimming device.

### BACKGROUND

In recent years, liquid crystal dimming films have been widely applied in fields such as eyeglasses, ski goggles, helmets, and more. These products typically use solar power with automatic switching controlled by light sensors, or are powered by rechargeable batteries with manual switches. However, in practical applications, solar power has certain limitations. Solar-powered dimming devices output voltage only in the presence of light, simultaneously driving an MCU (Microcontroller Unit) to control the corresponding output voltage, which in turn regulates the brightness of the liquid crystal film. In the absence of light, the solar power supply can instantly lose power, causing the entire power system to fail in providing output voltage. This results in the liquid crystal film instantly becoming dark or light (depending on the initial orientation of the liquid crystal molecules in the liquid crystal layer of the film), which can cause discomfort to the eyes of the user of the dimming device. For example, solar-powered automatic dimming eyeglasses generally use a liquid crystal film that darkens upon electrification. These glasses can be used as sunglasses while driving. When the car is under the sun, the solar panel generates power to darken the liquid crystal film. However, when suddenly passing through a shaded area or tunnel, the solar power cannot supply electricity in time, causing the liquid crystal film to instantly lighten. This sudden change can be uncomfortable for the driver's eyes, unable to quickly adapt to the change in light intensity, potentially leading to driving safety risks. Similarly, solar-powered dimming ski goggles also use a liquid crystal film that darkens upon electrification. When skiing, the reflection of sunlight off the snow powers the solar panel, darkening the liquid crystal film. After prolonged skiing, the film remains dark, but upon suddenly returning indoors where solar power cannot supply electricity in time, the film instantly lightens. This rapid change to bright light can cause discomfort and potential harm to the user's eyes.

The above situations primarily occur because the dimming device suddenly enters an environment with no or weak light, and the solar power cannot continue supplying electricity, causing the liquid crystal film to quickly lighten. This exposes the user's eyes to sudden light stimulation and can be accompanied by other risks. Therefore, there is a current need to design a dimming device that does not immediately cause the liquid crystal film to lighten when suddenly entering an environment with no or weak light, namely a delayed dimming device.

### SUMMARY

An objective of the present disclosure is to provide a delayed dimming device, aimed at addressing the technical issue where current dimming devices, upon suddenly entering an environment with no or weak light, cannot maintain power supply due to the limitations of solar energy, leading to the rapid lightening of the liquid crystal film. This rapid change causes discomfort due to light stimulation to the user's eyes and is accompanied by other potential risks.

To achieve the aforementioned objective, the present disclosure provides a delayed dimming device, including:
a first power supply system, said first power supply system being a solar power system, internally equipped with a photoreceptor, said photoreceptor being used for sensing the intensity of ambient light;
an automatic delay drive circuit, said first power supply system being connected to said automatic delay drive circuit;
a controller, said controller receives electrical signals transmitted by said automatic delay drive circuit; and
a dimming device, said controller being used for controlling said dimming device.

Said first power supply system powers said dimming device and senses the intensity of ambient light, said first power supply system transmits the sensed light intensity signal to said automatic delay drive circuit, said automatic delay drive circuit converts the light intensity signal into an electrical signal transmitted to said controller, said controller determines whether delayed dimming is necessary based on the transmitted electrical signal.

In an embodiment, said delayed dimming device further includes a second power supply system, said second power supply system being internally equipped with a backup battery, said second power supply system being connected to said automatic delay drive circuit, said first power supply system capable of charging the backup battery within said second power supply system.

In an embodiment, said delayed dimming device further includes a manual delay adjustment circuit, said manual delay adjustment circuit being connected to said controller, said manual delay adjustment circuit being capable of manually adjusting the duration of delayed dimming of said dimming device by said controller.

In an embodiment, said dimming device is equipped with a dimming film, said dimming film including sequentially stacked layers of a first substrate layer, a first conductive layer, a liquid crystal layer, a second conductive layer, and a second substrate layer; and
said controller is electrically connected to both said first conductive layer and said second conductive layer, used for applying a driving voltage to said first conductive layer and said second conductive layer.

In an embodiment, said automatic delay drive circuit includes a first diode, a second diode, a transistor, a first resistor, a second resistor, a third resistor, and a fourth resistor.

Under light exposure, said first power supply system directly powers said controller through the first diode D1, and simultaneously charges the backup battery in said second power supply system through the second diode D2 and the fourth resistor.

In an embodiment, said manual delay adjustment circuit is equipped with a physical switch, said physical switch having at least two adjustment positions, each of said adjustment positions corresponds to an output voltage of said controller.

On the other hand, the present disclosure provides a dimming eyeglasses, including the delayed dimming device of any one of the aforementioned claims. said dimming eyeglasses includes a frame, said delayed dimming device being fixedly installed on said frame.

In an embodiment, said dimming eyeglasses include temple arms, said delayed dimming device being fixedly installed on said temple arms.

In an embodiment, said dimming eyeglasses includes lenses, said dimming device being fixedly adhered to the surface of said lenses.

### BRIEF DESCRIPTION OF THE DRAWINGS

FIG. 1 is a schematic diagram of the circuit module connections for the delay dimming device of an embodiment of the present disclosure;

FIG. 2 is a circuit schematic of the delay dimming device of an embodiment of the present disclosure;

FIG. 3 is a schematic diagram showing the connection between the controller and the liquid crystal film of the delay dimming device of an embodiment of the present disclosure;

FIG. 4 is a structural schematic of the delay dimming device of an embodiment of the present disclosure when used in dimming glasses;

FIG. 5 is a schematic diagram of the circuit module connections for the delay dimming device of an embodiment of the present disclosure;

FIG. 6 is a circuit schematic of the delay dimming device of an embodiment of the present disclosure;

FIG. 7 is a structural schematic of the delay dimming device of an embodiment of the present disclosure when used in dimming glasses.

### LIST OF REFERENCE SIGNS

| | |
|---|---|
| First substrate layer 101 | First conductive layer 102 |
| Liquid crystal layer 103 | Second conductive layer 104 |
| Second substrate layer 105 | Frame 201 |
| Lens 202 | Temple arms 203 |
| Physical Switch 204 | |

### DETAILED DESCRIPTION

The following description, in conjunction with the accompanying drawings of embodiments of the present disclosure, provides a clear and complete explanation of the provided solutions in these embodiments. It is evident that the embodiments described herein represent only a part of the embodiments of the present disclosure and not all embodiments. Based on the embodiments in the present disclosure, all other embodiments obtained by those skilled in the art without any creative effort fall within the scope of protection of the present disclosure.

It should be noted that if directional indications (such as up, down, left, right, front, back, etc.) are involved in the embodiments of this application, these indications are solely for the purpose of explaining the relative position, motion, and other aspects of the components in a specific orientation (as shown in the drawings). If this specific orientation changes, then the directional indications will also change accordingly.

Furthermore, if descriptions such as “first,” “second,” and the like are used in the embodiments of this application, these terms are used solely for descriptive purposes and should not be interpreted as indicating or implying their relative importance or suggesting the number of technical features indicated. Therefore, the features defined as “first,” “second,” etc., can explicitly or implicitly include at least one such feature. Additionally, the technical solutions of various embodiments can be combined with each other, but such combinations must be based on the ability of those skilled in the art to implement them. If the combination of technical solutions results in contradictions or is not feasible, it should be considered that such a combination does not exist and is not within the scope of protection claimed in this application.

### Embodiment 1

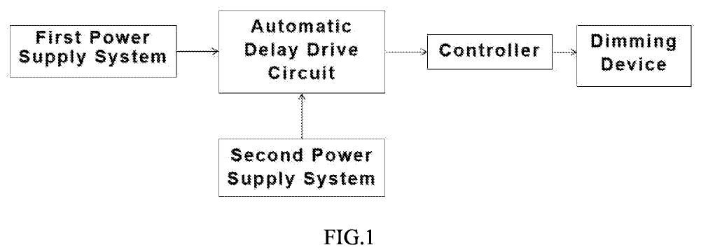

Referring to FIG. 1, an embodiment of the present disclosure provides a delayed dimming device, including: a first power supply system, an automatic delay drive circuit, a controller, a dimming device, and a second power supply system.

The first power supply system is a solar power system, internally equipped with a photoreceptor, which is used for sensing the intensity of ambient light. In this embodiment, the solar power system used in the first power supply system preferably employs solar thin films. Solar thin films have many advantages, such as: 1. Convenient production, high technical content, widely available raw materials, economical use of materials, mass production, and low cost. 2. Competitive pricing and high cost-performance ratio. 3. Light weight, extremely thin thickness (a few micrometers), flexibility, and simple manufacturing process. Applying solar thin films to the first power supply system of the present disclosure can significantly reduce the volume and weight of the product, while also meeting the requirements for the supply voltage. The photoreceptor within the first power supply system is a commonly used type, readily available for purchase in the market, and is primarily used for sensing the intensity of ambient light.

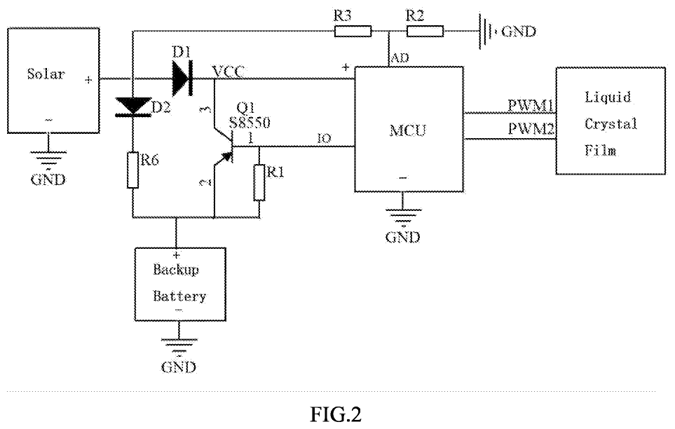

Referring to FIG. 2, the first power supply system is connected to the automatic delay drive circuit. The automatic delay drive circuit includes a first diode D1, a second diode D2, a transistor Q1, a first resistor R1, a second resistor R2, a third resistor R3, and a fourth resistor R4. When exposed to light, the first power supply system directly powers the controller through the first diode D1. The controller receives electrical signals transmitted by the automatic delay drive circuit and is used to control the dimming device, which utilizes a liquid crystal film. The second power supply system is internally equipped with a backup battery and is connected to the automatic delay drive circuit, with the first power supply system capable of charging the backup battery within the second power supply system. The first power supply system powers the dimming device and senses the intensity of ambient light, transmitting the sensed light intensity signal to the automatic delay drive circuit. The automatic delay drive circuit then converts the light intensity signal into an electrical signal transmitted to the controller, which determines whether delayed dimming is necessary based on the transmitted electrical signal. In this embodiment, the liquid crystal film used in the dimming device darkens upon electrification. The darkening or lightening of the liquid crystal film indeed depends on the initial orientation of the liquid crystal molecules in the liquid crystal layer 103 of the film. Liquid crystal displays utilize this principle, changing the arrangement of molecules within the liquid crystal material by applying voltage, thereby achieving the purpose of blocking or allowing light to pass through, resulting in varying levels of display brightness. The initial orientation of the liquid crystal molecules is influenced by the DC blocking effect of the alignment layer, and applying voltage of the same polarity for an extended period can also cause the movable ions in the liquid crystal layer 103 to generate an internal electric field, leading to certain rearrangements of the liquid crystals even without applied voltage. Additionally, the response time of the liquid crystal molecules also affects their response speed to changes in the electric field, that is, the time it takes to transition from dark to light or from light to dark.

As shown in FIG. 2, in this embodiment, the controller is an MCU (Microcontroller Unit) unit, and the model of transistor Q1 is S8550. When exposed to light, the solar power system directly powers the MCU unit through the first diode D1, and the MCU unit outputs control waveforms to regulate the brightness of the liquid crystal film. At the same time, the second diode D2 and the fourth resistor R4 charge the backup battery. When the ambient light is insufficient for the solar power system to generate electricity, the signal after being divided by the resistors R3 and R2 is transmitted to the AD port of the MCU unit. The AD port of the MCU unit determines the presence and intensity of light. If there is no light or only weak light, the MCU unit, based on the factory software preset values for the dimming device, timely collects signals of no light or weak light through the AD port. In conditions of no light or weak light, the IO port of the MCU unit outputs a low level to control transistor Q1, enabling transistor Q1 to conduct and subsequently control the power supply to the MCU unit. The MCU unit can continue to function and control the output. The time for the output voltage of the MCU unit to slowly increase can be preset, thereby achieving delayed brightening of the liquid crystal film.

It is particularly noteworthy that the solar power system is not limited in terms of voltage range, the backup battery is not restricted in capacity, transistor Q1 is not limited to any specific electronic switch or physical switch, and the MCU is not brand specific. All these aspects fall within the scope of the patent protection and can be replaced with corresponding components according to actual needs.

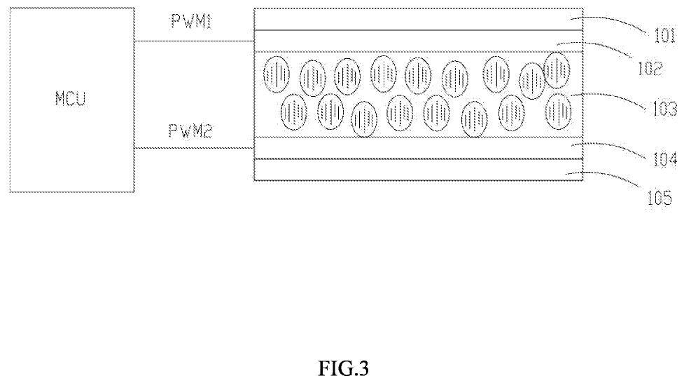

Referring to FIG. 3, the dimming film includes sequentially stacked layers of a first substrate layer 101, a first conductive layer 102, a liquid crystal layer 103, a second conductive layer 104, and a second substrate layer 105. The controller is electrically connected to both the first conductive layer 102 and the second conductive layer 104, used for applying driving voltage to the first conductive layer 102 and the second conductive layer 104. The PWM1 and PWM2 interfaces of the MCU unit are electrically connected to the first conductive layer 102 and the second conductive layer 104, respectively, thereby enabling the application of voltage to the liquid crystal layer 103. The dimming film is a liquid crystal dimming film, which offers many advantages, especially compared to traditional dimming glasses. Traditional dimming glasses incorporate silver halide chemicals into lens 202, causing the originally transparent and colorless lens 202 to become colored under strong light exposure. Silver halide undergoes a reversible dimming reaction under sunlight and ultraviolet radiation, decomposing into silver and halogen, rapidly darkening, fully absorbing ultraviolet light, and showing neutral absorption to visible light; in dark environments, it recombines into silver halide, allowing lens 202 to return to being colorless and transparent. The benefits of using liquid crystal dimming film in this embodiment include the following: high reliability, as the invention uses liquid crystals as the primary dimming material, which, compared to traditional silver halide chemicals, do not degrade or attenuate, offering higher reliability and longevity; rapid response, as liquid crystals flip through changes in the electric field, responding much faster than the slow chemical reactions of silver halide, providing quicker dimming response times, capable of completing dimming in less than or equal to 100 milliseconds; uniform color change, as liquid crystal dimming technology achieves a uniform color change effect, with liquid crystals changing according to the direction of the electric field, and the conductive layer providing a uniform parallel electric field, thus ensuring consistent dimming; controllable delay dimming, as the invention employs an automatic delay drive circuit, allowing users to select products with factory preset delayed dimming times according to their needs, enabling flexible control over the duration of delayed dimming. In summary, compared to traditional silver halide dimming glasses, the present disclosure offers higher reliability, faster response speed, more uniform color change effects, and controllable delayed dimming functionality, effectively addressing the safety risks associated with rapid color changes in shaded areas and tunnels while driving.

In summary, in this embodiment, the delayed dimming device uses a solar power system as the first power supply system, incorporating a photoreceptor to sense the intensity of ambient light. An automatic delay drive circuit is employed, connecting the first power supply system to the automatic delay drive circuit to achieve the delayed dimming functionality. A controller is introduced to receive electrical signals transmitted by the automatic delay drive circuit and to determine whether delayed dimming is necessary based on these signals. A dimming device is set up and controlled by the controller. The first power supply system powers the dimming device and senses the intensity of ambient light. The sensed light intensity signal is transmitted from the first power supply system to the automatic delay drive circuit, then converted into an electrical signal and transmitted to the controller. A second power supply system is added, equipped with a backup battery and connected to the automatic delay drive circuit. The first power supply system can charge the backup battery within the second power supply system. The dimming device is equipped with a dimming film, including sequentially stacked layers of a first substrate layer 101, a first conductive layer 102, a liquid crystal layer 103, a second conductive layer 104, and a second substrate layer 105. The controller is electrically connected to both the first conductive layer 102 and the second conductive layer 104, used for applying driving voltage to these layers. The automatic delay drive circuit includes a first diode D1, a second diode D2, a transistor Q1, a first resistor R1, a second resistor R2, a third resistor R3, and a fourth resistor R4. When the first power supply system is exposed to light, it directly powers the controller through the first diode D1, while also charging the energy storage battery in the second power supply system through the second diode D2 and the fourth resistor R4. Through these technical means, automatic delayed dimming of the delayed dimming device can be achieved. The solar power system and photoreceptor sense the intensity of ambient light, and signal transmission and determination are carried out through the automatic delay drive circuit and controller, enabling automatic dimming functionality. Additionally, the inclusion of a second power supply system and energy storage battery provides a backup power source for the delayed dimming device. The dimming film on the dimming device uses liquid crystal materials, characterized by high reliability, rapid response, and uniform color change, and also possesses the functionality of controllable delayed dimming.

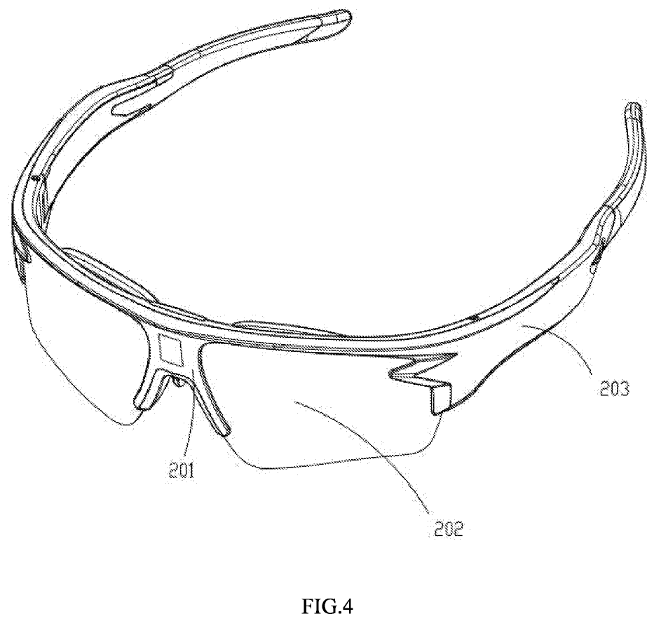

Referring to FIG. 4, FIG. 4 illustrates a pair of dimming eyeglasses using the delayed dimming device provided in this embodiment. In the delayed dimming device, the first power supply system, automatic delay drive circuit, controller, and second power supply system are all integrated and fixedly installed in the central part of the frame 201 of the dimming eyeglasses, specifically between the two lenses 202. The dimming device is the dimming film, with each of the two lenses 202 equipped with a dimming film. The dimming film is adhered and fixed to either the inner or outer surface of lens 202. In this embodiment, the dimming film of the dimming eyeglasses is adhered and fixed on the side closer to the user's eyes, allowing lens 202 to act as a protective layer for the dimming film.

In the dimming eyeglasses of this embodiment, the first substrate layer 101 and the second substrate layer 105 within the dimming film are made of flexible transparent materials, such as PC (Polycarbonate), PET (Polyethylene Terephthalate), TAC (Triacetate Cellulose), COC (Cyclic Olefin Copolymer), or COP (Cyclic Olefin Polymer). In this embodiment, PC material is preferably selected as the material for these substrate layers. The first conductive layer 102 and the second conductive layer 104 are transparent conductive layers, with ITO (Indium Tin Oxide) material being the preferred choice for the conductive layer material in this embodiment. The liquid crystal layer 103 uses GH liquid crystal material. Under the influence of an external electric field, the dye molecules rotate along with the liquid crystal molecules. Dichroic dyes exhibit anisotropy in light absorption and based on the orientation relationship between the absorption axis of the dye molecules and the molecular axis, dichroic dyes can be classified into positive (P-type) and negative (N-type) dichroic dyes. When the E vector of light is perpendicular to the optical axis of the dye, the light is mostly transmitted; however, when the E vector of light is parallel to the optical axis of the dye, the light is mostly absorbed. This type of dye is a positive dichroic dye, while the negative dichroic dye behaves in the opposite manner. Based on the characteristics of positive and negative dyes, they absorb or transmit light, thereby changing the transmittance of the liquid crystal layer 103. Since guest-host liquid crystals can be used without polarizing films and utilize dichroic dyes for selective light transmission, they can meet the performance requirements of eyeglass lenses 202. They can achieve the adjustment of the brightness of lens 202 while maintaining high transparency, and also adjust the color of lens 202 in a dark state through the color of the dichroic dyes.

### Embodiment 2

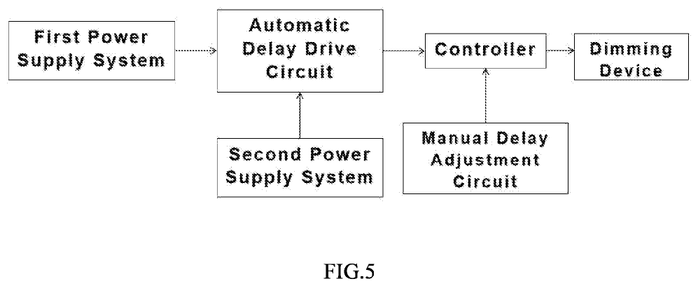

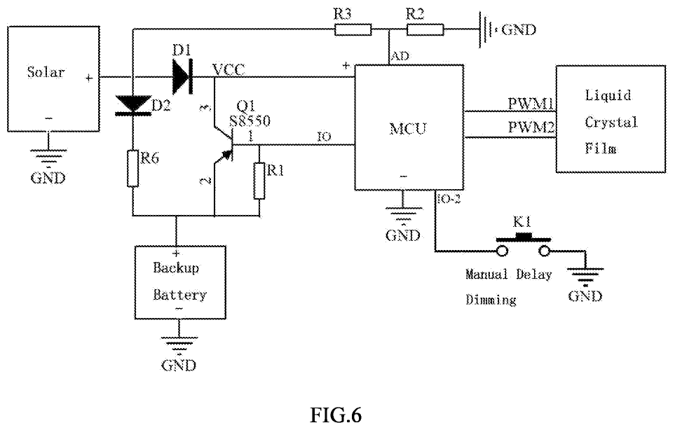

Referring to FIG. 5 and FIG. 6, an embodiment of the present disclosure provides a delayed dimming device, including: a first power supply system, an automatic delay drive circuit, a controller, a dimming device, a second power supply system, and a manual delay adjustment circuit. The first power supply system is a solar power system, internally equipped with a photoreceptor, which is used for sensing the intensity of ambient light. The first power supply system is connected to the automatic delay drive circuit. The controller receives electrical signals transmitted by the automatic delay drive circuit and is used to control the dimming device. The second power supply system is internally equipped with a backup battery and is connected to the automatic delay drive circuit, with the first power supply system capable of charging the backup battery within the second power supply system. The manual delay adjustment circuit is connected to the controller and can manually adjust the duration of delayed dimming of the dimming device by the controller. The first power supply system powers the dimming device and senses the intensity of ambient light, transmitting the sensed light intensity signal to the automatic delay drive circuit. The automatic delay drive circuit then converts the light intensity signal into an electrical signal transmitted to the controller, which determines whether delayed dimming is necessary based on the transmitted electrical signal. The delayed dimming device also includes a second power supply system, which is internally equipped with a backup battery. The second power supply system is connected to the automatic delay drive circuit, and the first power supply system can charge the backup battery within the second power supply system. The manual delay adjustment circuit is equipped with a physical switch 204, which has at least two adjustment positions. Each adjustment position corresponds to an output voltage of the controller.

In this embodiment, the dimming film used in the dimming device is the same as that in Embodiment 1. The dimming film includes sequentially stacked layers of a first substrate layer 101, a first conductive layer 102, a liquid crystal layer 103, a second conductive layer 104, and a second substrate layer 105. The controller is electrically connected to both the first conductive layer 102 and the second conductive layer 104, used for applying driving voltage to the first conductive layer 102 and the second conductive layer 104. The controller is an MCU (Microcontroller Unit) unit, with the MCU unit's PWM1 and PWM2 interfaces electrically connected to the first conductive layer 102 and the second conductive layer 104, respectively, thereby enabling the application of voltage to the liquid crystal layer 103. The automatic delay drive circuit includes the first diode D1, the second diode D2, a transistor Q1, a first resistor R1, a second resistor R2, a third resistor R3, and a fourth resistor R4. When exposed to light, the first power supply system directly powers the controller through the first diode D1, while also charging the backup battery in the second power supply system through the second diode D2 and the fourth resistor R4. The IO-2 port of the MCU unit is connected to the manual delay adjustment circuit, receiving the adjustment signals from the manual delay adjustment circuit through the IO-2 port. Through the above embodiment, both automatic delayed dimming and manual delay adjustment functionalities of the delayed dimming device can be achieved. The solar power system and photoreceptor are used to sense the intensity of ambient light, with signal transmission and determination carried out through the automatic delay drive circuit and controller, enabling the automatic dimming functionality. Additionally, the inclusion of a second power supply system and backup battery provides a backup power source for the delayed dimming device. Through the manual delay adjustment circuit, users can manually adjust the duration of delayed dimming of the dimming device according to their needs. The dimming film on the dimming device uses liquid crystal materials, characterized by high reliability, rapid response, and uniform color change, and also possesses the functionality of controllable delayed dimming.

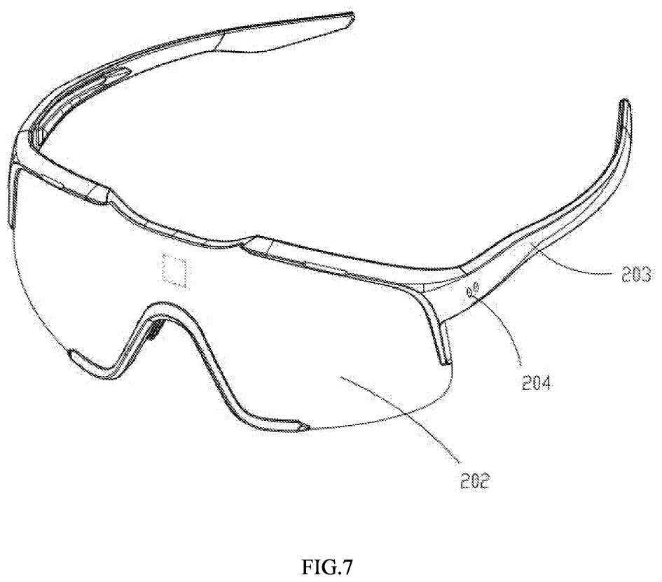

Referring to FIG. 7, FIG. 7 illustrates a pair of dimming eyeglasses using the delayed dimming device provided in this embodiment. In the delayed dimming device, the first power supply system, automatic delay drive circuit, controller, and second power supply system are all integrated and fixedly installed in the central part of the frame 201 of the dimming eyeglasses, specifically between the two lenses 202. The arrangement of the dimming film is the same as in Embodiment 1, positioned on the side of the eyeglass lenses 202 closer to the user's eyes. The difference from Embodiment 1 is that the manual delay adjustment circuit of the delayed dimming device is located on the temple arms 203 of the dimming eyeglasses. In this embodiment, the physical switch 204 on the manual delay adjustment circuit is designed as two buttons, used to adjust the voltage levels of the output. Each voltage level has been preset at the factory. The two buttons serve to increase or decrease the delay time settings. For example, each press of the increase button adds 0.5 seconds to the delayed dimming time, allowing users to set the delay time according to their actual needs. Alternatively, the physical switch 204 on the manual delay adjustment circuit can also be designed as a single button, using a single button to set the control logic of the physical switch 204. For instance, this button could have five adjustment positions, each incrementally adding 1 second to the delayed dimming time. Pressing the button cycles to the next position, and upon reaching the last position, another press resets it to the initial position, forming a cycle of adjustment positions. Both of these adjustment schemes can be designed according to actual user needs, but they must be preset at the factory, offering personalized services to manufacture the product.

Compared to existing technologies, the beneficial effects of the technical solution of the present disclosure are as follows:

The delayed dimming device provided by the present disclosure, under the condition of the solar power system being exposed to light, directly powers the controller through the first diode D1. The controller outputs a control voltage waveform to regulate the brightness of the liquid crystal film, while the second diode D2 and the fourth resistor R4 charge the backup battery. When the solar power system and the photoreceptor sense a weakening or complete absence of ambient light, the signal is sent to the controller after being divided by the resistors R3 and R2. The controller then assesses the presence and intensity of light. In the absence of light or under weak light conditions, the controller, based on preset values, outputs a low level to control the transistor Q1, enabling the transistor Q1 to conduct and subsequently control the power supply to the controller. This allows the controller to continue functioning and controlling the output. At this time, the voltage output by the controller enables the dimming device to slowly brighten, achieving delayed dimming. Through the manual delay adjustment circuit, users can manually adjust the duration of the delayed dimming of the dimming device according to their needs. The dimming film on the dimming device uses liquid crystal materials, which are characterized by high reliability, rapid response, and uniform color change, and also possess the functionality of controllable delayed dimming.

It should be noted that the technical solutions of the various embodiments of the present disclosure can be combined with each other, but such combinations must be based on the ability of those skilled in the art to implement them. If the combination of technical solutions results in contradictions or is not feasible, it should be considered that such a combination does not exist and is not within the scope of protection sought by the present disclosure.

The descriptions provided above represent only some or preferred embodiments of the present disclosure and should not limit the scope of protection of the present disclosure, whether in text or in the drawings. Any equivalent structural modifications made under the overall concept of the present disclosure, using the contents of the specification and drawings of the present disclosure, or direct/indirect applications in other related technical fields, are included within the scope of protection of the present disclosure.

What is claimed is:

1. A delayed dimming device, comprising:
a first power supply system, said first power supply system being a solar power system, internally equipped with a photoreceptor;
an automatic delay drive circuit, said first power supply system being connected to said automatic delay drive circuit;
a controller, said controller receives electrical signals transmitted by said automatic delay drive circuit; and
a dimming device, said controller being configured for controlling said dimming device,
wherein said first power supply system powers said dimming device and senses light intensity of ambient light, said first power supply system transmits a signal representing sensed light intensity to said automatic delay drive circuit, said automatic delay drive circuit converts the signal into an electrical signal transmitted to said controller, and said controller determines whether delayed dimming is performed based on the electrical signal.

2. The delayed dimming device according to claim 1, further comprising: a second power supply system, wherein said second power supply system is internally equipped with a backup battery, said second power supply system is connected to said automatic delay drive circuit, and said first power supply system is configured to charge the backup battery within said second power supply system.

3. The delayed dimming device according to claim 1, further comprising a manual delay adjustment circuit, wherein said manual delay adjustment circuit is connected to said controller, and said manual delay adjustment circuit is configured to manually adjust a duration of delayed dimming of said dimming device by said controller.

4. The delayed dimming device according to claim 1, wherein said dimming device is equipped with a dimming film, said dimming film comprising sequentially stacked layers of a first substrate layer, a first conductive layer, a liquid crystal layer, a second conductive layer, and a second substrate layer; and
said controller is electrically connected to both said first conductive layer and said second conductive layer, to apply a driving voltage to said first conductive layer and said second conductive layer.

5. The delayed dimming device according to claim 2, wherein said automatic delay drive circuit comprises a first diode, a second diode, a transistor, a first resistor, a second resistor, a third resistor, and a fourth resistor; and
wherein under light exposure, said first power supply system directly powers said controller through the first diode, and simultaneously charges the backup battery in said second power supply system through the second resistor and the fourth resistor.

6. The delayed dimming device according to claim 3, wherein said manual delay adjustment circuit is equipped with a physical switch, said physical switch having at least two adjustment positions, and each of said adjustment positions corresponds to an output voltage of said controller.

7. A dimming eyeglass, comprising a delayed dimming device,
wherein the delayed dimming device comprises:
a first power supply system, said first power supply system being a solar power system, internally equipped with a photoreceptor;
an automatic delay drive circuit, said first power supply system being connected to said automatic delay drive circuit;
a controller, said controller receives electrical signals transmitted by said automatic delay drive circuit; and
a dimming device, said controller being configured for controlling said dimming device, and
wherein said first power supply system powers said dimming device and senses light intensity of ambient light, said first power supply system transmits a signal representing sensed light intensity to said automatic delay drive circuit, said automatic delay drive circuit converts the signal into an electrical signal transmitted to said controller, and said controller determines whether delayed dimming is performed based on the electrical signal.

8. The dimming eyeglasses according to claim 7, wherein the delayed dimming device further comprises a second power supply system, said second power supply system is internally equipped with a backup battery, said second power supply system is connected to said automatic delay drive circuit, and said first power supply system is configured to charge the backup battery within said second power supply system.

9. The dimming eyeglasses according to claim 7, wherein the delayed dimming device further comprises a manual delay adjustment circuit, said manual delay adjustment circuit is connected to said controller, and said manual delay adjustment circuit is configured to manually adjust a duration of delayed dimming of said dimming device by said controller.

10. The dimming eyeglasses according to claim 7, wherein said dimming device is equipped with a dimming film, said dimming film comprising sequentially stacked layers of a first substrate layer, a first conductive layer, a liquid crystal layer, a second conductive layer, and a second substrate layer; and
said controller is electrically connected to both said first conductive layer and said second conductive layer, to apply a driving voltage to said first conductive layer and said second conductive layer.

11. The dimming eyeglasses according to claim 8, wherein said automatic delay drive circuit comprises a first diode, a second diode, transistor, a first resistor, a second resistor, a third resistor, a fourth resistor; and
wherein under light exposure, said first power supply system directly powers said controller through the first diode, and simultaneously charges the backup battery in said second power supply system through the second resistor and the fourth resistor.

12. The dimming eyeglasses according to claim 9, wherein said manual delay adjustment circuit is equipped with a physical switch, said physical switch having at least two adjustment positions, and each of said adjustment positions corresponds to an output voltage of said controller.

13. The dimming eyeglasses according to claim 7, further comprises a frame, said delayed dimming device being fixedly installed on said frame.

14. The dimming eyeglasses according to claim 7, further comprising temple arms, said delayed dimming device being fixedly installed on said temple arms.

15. The dimming eyeglasses according to claim 7, further comprising lenses, said dimming device being fixedly adhered to a surface of said lenses.
